(19) United States
(12) Patent Application Publication
(10) Pub. No.: US 2025/0033721 A1
(43) Pub. Date: Jan. 30, 2025

(54) BICYCLE KICKSTAND

(71) Applicant: HAIDONG GU, Pomona, CA (US)

(72) Inventor: HAIDONG GU, Pomona, CA (US)

(21) Appl. No.: 18/225,696

(22) Filed: Jul. 25, 2023

(51) Int. Cl. B62H 1/02

(52) U.S. Cl. CPC B62H 1/02

(57) ABSTRACT

Provided is a bicycle kickstand including: a stand having a coupling portion with a top surface on which a plurality of friction bumps are disposed; and a packing component made of a resilient material and having a first packing block and a second packing block, with the first packing block coupled to the coupling portion of the stand, and the second packing block coupled between the first packing block and a fitting component. The first packing block and the second packing block are fitted to upper and lower sides of two chainstay tubes of a bicycle frame, respectively, to couple the stand tightly to between the two chainstay tubes of the bicycle frame, preclude damage which might otherwise be caused to the two chainstay tubes, and enable the stand to firmly support the bicycle.

### FIELD

The present disclosure relates to bicycles, and more particularly to a bicycle kickstand.

### BACKGROUND

In general, every bicycle is kept upright when supported by a kickstand coupled to the bicycle frame. Conventional kickstands each essentially have a standing support. One end of the standing support is pivotally connected to a fitting unit. The fitting unit has an upper fitting hole and has a fixing screw penetratingly fitted in place in the direction of the upper fitting hole to operate in conjunction with a clamping plate. The fitting unit abuts against the lower sides of two chainstay tubes so as for the fitting unit to be positioned proximate to a bottom bracket of the bicycle frame, allowing the upper fitting hole to be located between the two chainstay tubes. Then, the clamping plate abuts against the upper sides of the two chainstay tubes and faces the fitting unit. The fixing screw meshes with the upper fitting hole to keep the clamping plate close to the fitting unit and thereby tightly fixed to the two chainstay tubes. Thus, the kickstand is capable of performing reciprocating swings pivotally between a supporting state and a folded state. The kickstand is perpendicular to the ground in the supporting state to allow the bicycle to stand upright and is parallel to the ground in the folded state.

### SUMMARY

It is an objective of the disclosure to provide a bicycle kickstand with a packing component made of a resilient material and adapted to function as an assembly medium between the kickstand and a bicycle frame so as to enhance assembly stability and protect the bicycle frame against any damage otherwise caused by insufficient assembly tightness while the bicycle is in use.

To achieve the above and other objectives, the disclosure provides a bicycle kickstand, comprising: a stand having a coupling portion, wherein a plurality of friction bumps are disposed on the top surface of the coupling portion; a packing component made of a resilient material and having a first packing block and a second packing block, with the first packing block coupled to the coupling portion of the stand and being in contact with the friction bumps of the coupling portion, and the second packing block coupled between the first packing block and a fitting component. The first packing block and the second packing block are fitted to the lower sides and the upper sides of the two chainstay tubes of the bicycle, respectively, to enable the stand to be tightly coupled between the two chainstay tubes of a bicycle frame, enhance assembly tightness, allow the stand to support the bicycle steadily, and prevent the two chainstay tubes, the fitting component and the coupling portion of the stand from loosening from each other to the detriment of the two chainstay tubes of the bicycle frame.

The friction bumps are round, conical or cubic in shape.

Regarding the bicycle kickstand, a plurality of coupling dents are disposed on the top surface of the coupling portion, and a plurality of coupling blocks corresponding in position to the coupling dents on the coupling portion are disposed at the first packing block.

Regarding the bicycle kickstand, a plurality of first ribs are disposed on the upper surface of the first packing block, and a plurality of second ribs corresponding in position to the first ribs of the first packing block are disposed on the lower surface of the second packing block.

Regarding the bicycle kickstand, the first ribs and the second ribs are arranged in a grid pattern.

Regarding the bicycle kickstand, a short side of the coupling portion has an oblique surface with a gradually decreasing thickness, and the oblique surface is conducive to increasing an angle by which the stand pivotally swings.

Regarding the bicycle kickstand, two position-limiting trenches are concavely disposed on two long sides of the second packing block, respectively, and two position-limiting portions are convexly disposed on two long sides of the fitting component and correspond in position to the position-limiting trenches of the second packing block, respectively.

Regarding the bicycle kickstand, an upper surface of the fitting component curves inward and concavely and extends downward to form the position-limiting portions which are plate-shaped.

Regarding the bicycle kickstand, a plurality of embedding posts are disposed on the upper surface of the second packing block, and a plurality of embedding holes are disposed on the lower surface of the fitting component and correspond in position to the embedding posts of the second packing block, respectively.

Regarding the bicycle kickstand, the coupling portion, the first packing block, the second packing block and the fitting component each have a fixing hole. The fixing holes correspond in position to each other and are penetrated by a fixing component.

### BRIEF DESCRIPTION OF THE DRAWINGS

FIG. 1 is an exploded view of a bicycle kickstand of the disclosure.

FIG. 2 is another exploded view of the bicycle kickstand of the disclosure from another angle of view.

FIG. 3 is a perspective view of the bicycle kickstand of the disclosure.

FIG. 4 is a cross-sectional view of the bicycle kickstand taken along line IV-IV of FIG. 3 according to the disclosure.

FIG. 5 is a cross-sectional view of the bicycle kickstand taken along line V-V of FIG. 3 according to the disclosure.

FIG. 6 is a top view, showing an oblique surface of a coupling portion of FIG. 3.

FIG. 7 is a perspective view, showing a stand mounted on chainstay tubes of a bicycle frame according to the disclosure.

FIG. 8 is a cross-sectional view of the bicycle kickstand taken along line VII-VII of FIG. 7 according to the disclosure.

FIG. 9 is a partial enlarged view of the bicycle kickstand shown in FIG. 8 according to the disclosure.

### DETAILED DESCRIPTION

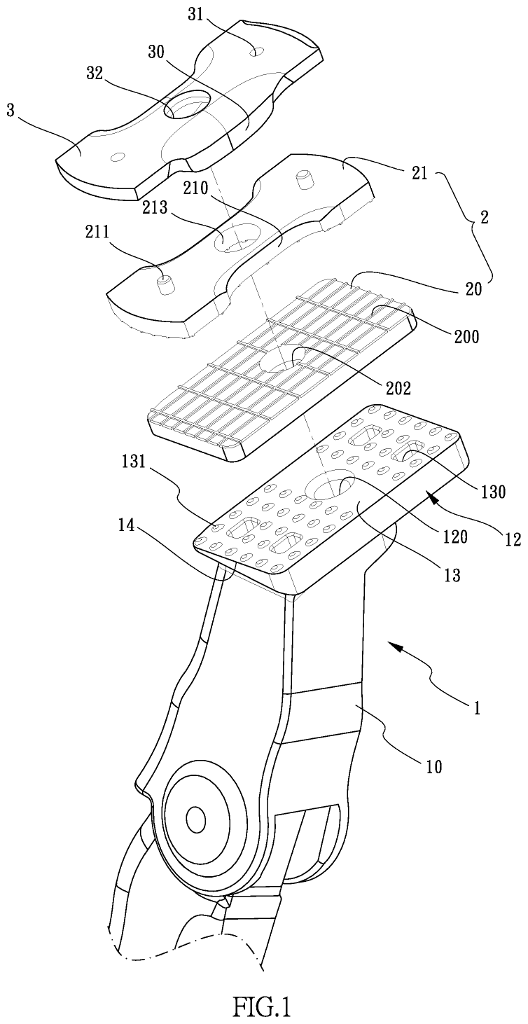

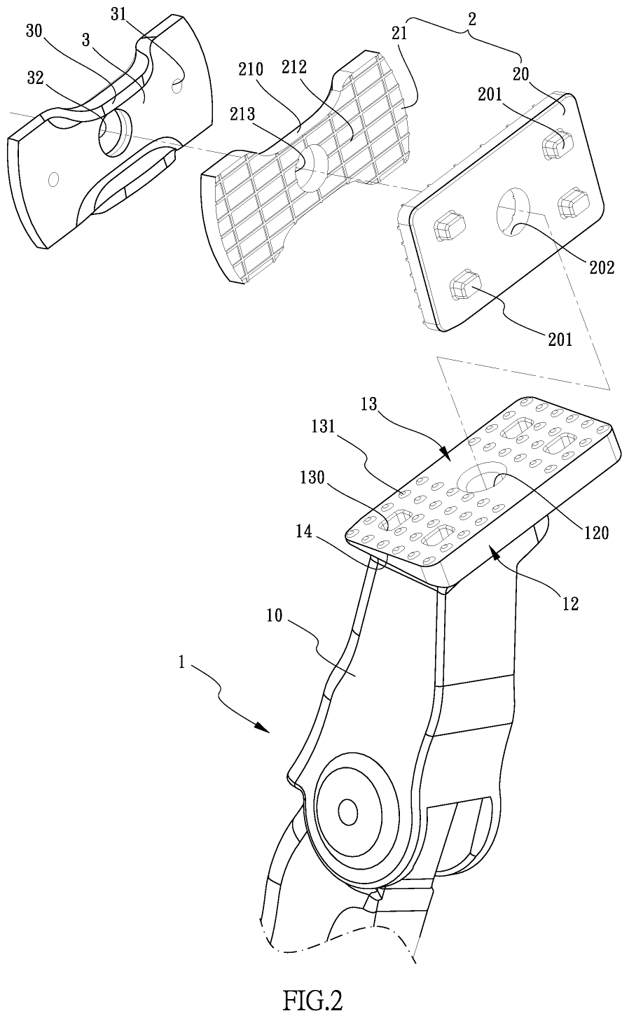

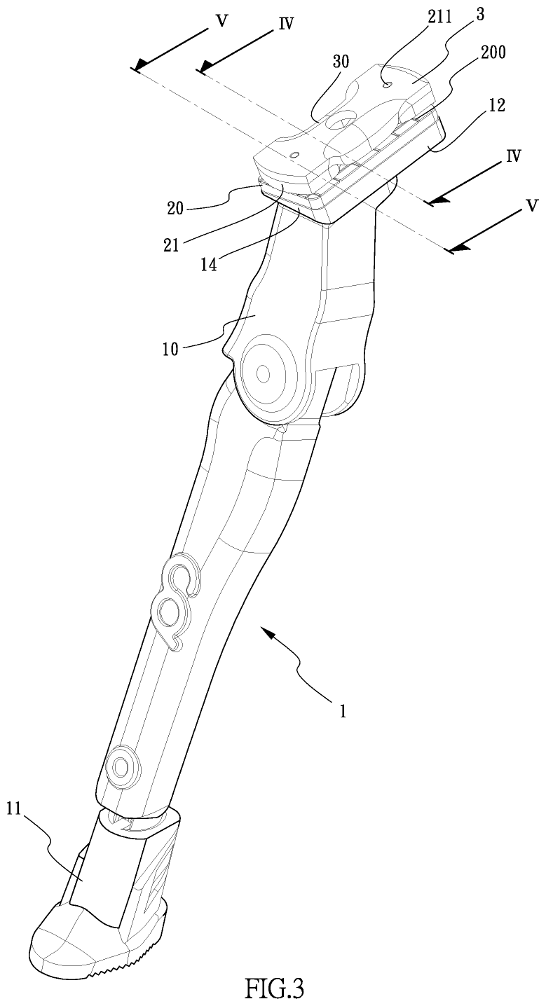

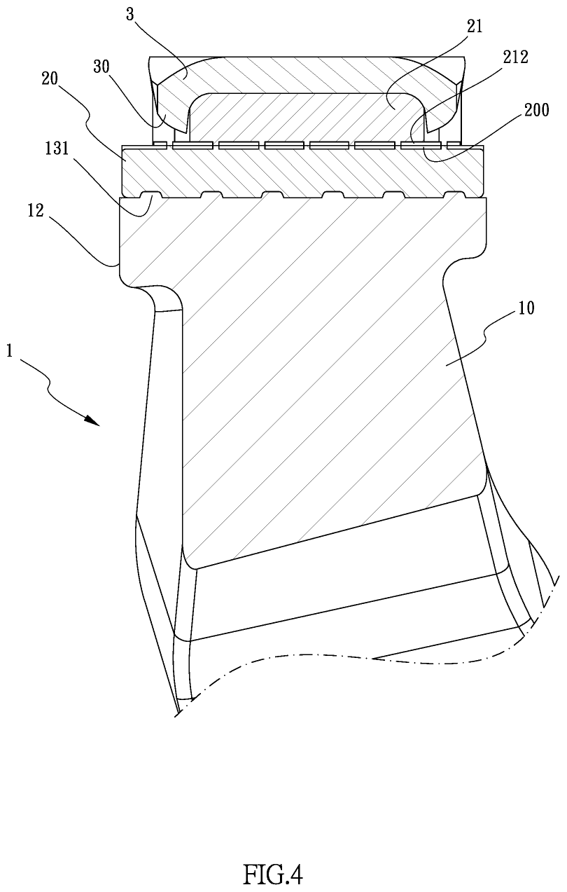

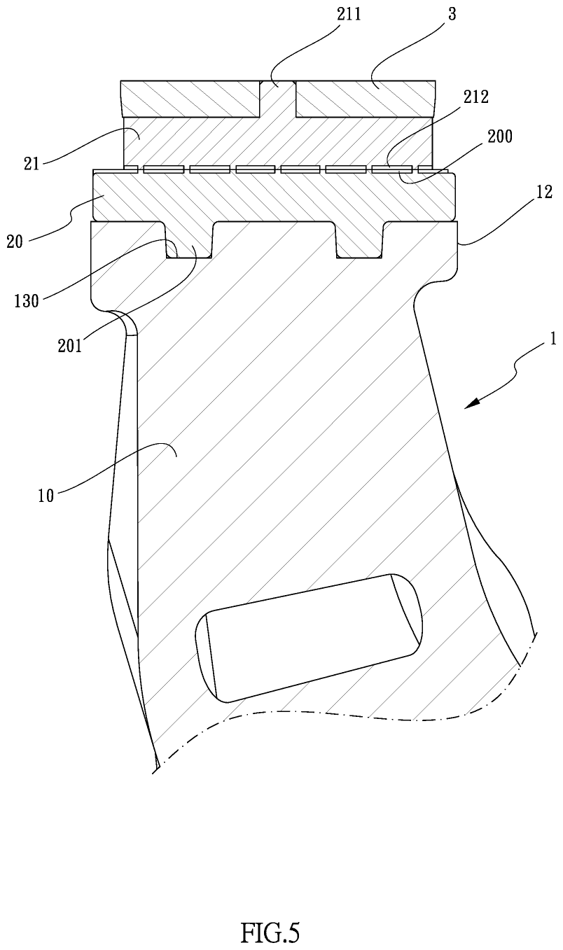

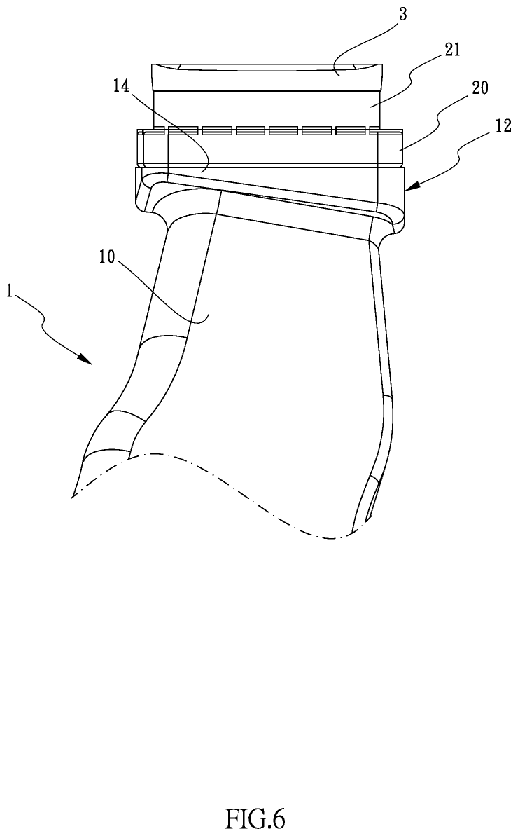

Referring to FIG. 1 through FIG. 9, a bicycle kickstand of the disclosure comprises a stand 1, a packing component 2 and a fitting component 3.

The stand 1 has two ends at which a pivotal connection portion 10 and a hooflike portion 11 are disposed, respectively. The pivotal connection portion 10 is connected to a coupling portion 12. The coupling portion 12 has a a top surface 13. The top surface 13 has a plurality of coupling dents 130 and a plurality of friction bumps 131. The friction bumps 131 are round, conical or cubic in shape.

The short side of the coupling portion 12 has an oblique surface 14 with a gradually decreasing thickness. Owing to the oblique surface 14, the stand 1 connected to the coupling portion 12 always pivotally swings upward or downward by a large angle, exhibiting enhanced ease of use.

The packing component 2 has a first packing block 20 and a second packing block 21.

The upper surface of the first packing block 20 has a plurality of first ribs 200 arranged in a grid pattern. The lower surface of the first packing block 20 has a plurality of coupling blocks 201 corresponding in position to the coupling dents 130 of the coupling portion 12, respectively.

Two position-limiting trenches 210 are concavely disposed on the two long sides of the second packing block 21, respectively. A plurality of embedding posts 211 are disposed on the upper surface of the second packing block 21. A plurality of second ribs 212 corresponding in position to the first ribs 200 of the first packing block 20 are disposed on the lower surface of the second packing block 21. In this embodiment, the first packing block 20 and the second packing block 21 of the packing component 2 are made of a resilient, composite material comprising rubbers bonded to fibers.

Two position-limiting portions 30 are convexly disposed on two long sides of the fitting component 3 and correspond in position to the position-limiting trenches 210 of the second packing block 21, respectively. The upper surface of the fitting component 3 curves inward and concavely and extends downward to form the position-limiting portions 30 which are plate-shaped. A plurality of embedding holes 31 are disposed on the lower surface of the fitting component 3 and correspond in position to the embedding posts 211 of the second packing block 21, respectively.

The structural relationships of the aforesaid constituent elements are further described below. The first packing block 20 is coupled to the top surface 13 of the coupling portion 12 of the stand 1, and thus the coupling blocks 201 of the first packing block 20 are coupled to the coupling dents 130 of the coupling portion 12, respectively. The second packing block 21 is coupled to the upper surface of the first packing block 20, and thus the first ribs 200 of the first packing block 20 correspond in position to the second ribs 212 of the second packing block 21, respectively. The fitting component 3 is coupled to the upper surface of the second packing block 21 to not only allow the position-limiting portions 30 of the fitting component 3 to abut against the outer side of the position-limiting trenches 210 of the second packing block 21 but also allow the embedding holes 31 of the fitting component 3 to engage with the embedding posts 211 of the second packing block 21, respectively.

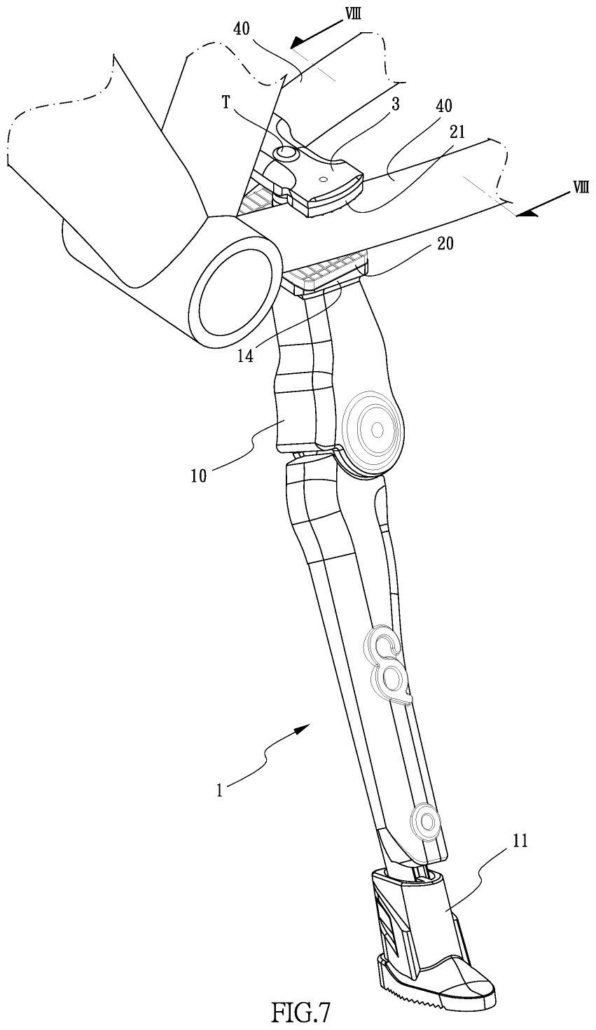

Referring to FIG. 7 through FIG. 9, a process of mounting the bicycle kickstand of the disclosure on a bicycle frame 4 entails coupling the coupling portion 12 of the stand 1 to the first packing block 20, abutting the first packing block 20 against the lower sides of two chainstay tubes 40 so as for the first packing block 20 to be positioned proximate to a bottom bracket of the bicycle frame 4, coupling the fitting component 3 and the second packing block 21 to each other, abutting the second packing block 21 against the upper sides of the two chainstay tubes 40, and passing a fixing component T sequentially through a fixing hole 120 of the coupling portion 12, a fixing hole 202 of the first packing block 20, a fixing hole 213 of the second packing block 21 and a fixing hole 32 of the fitting component 3 to allow the second packing block 21 and the first packing block 20 to be fitted to the upper and lower sides of the two chainstay tubes 40 of the bicycle frame 4, respectively.

The hooflike portion 11 of the stand 1 is in contact with the ground; thus, the user can leave the bicycle stationary, fixed, and unlikely to topple. To start riding the bicycle, the user merely has to pivotally swing the stand 1 upward with the pivotal connection portion 10 to cause the stand 1 to be not in contact with the ground.

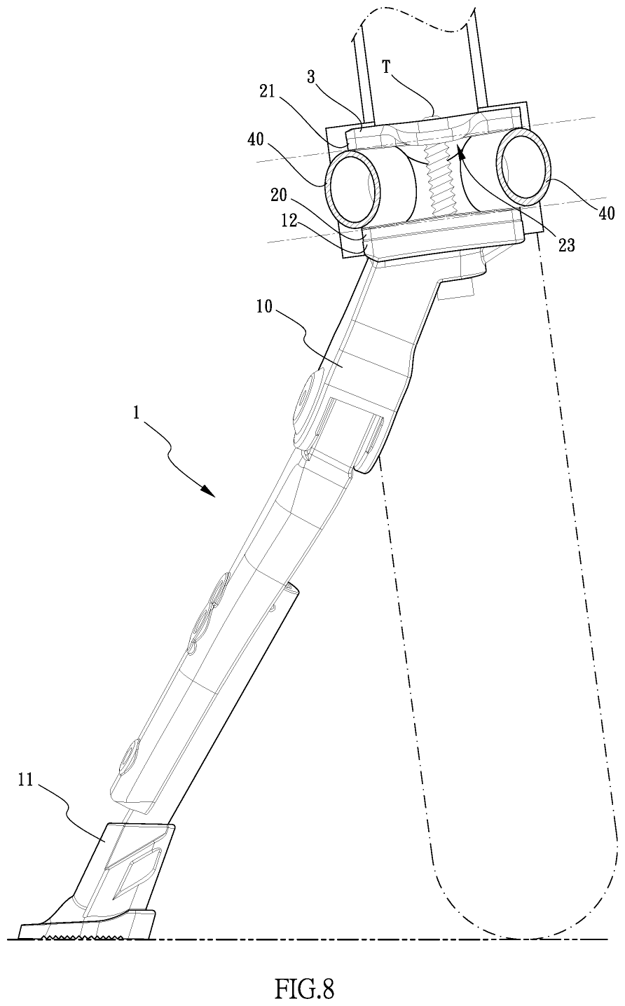

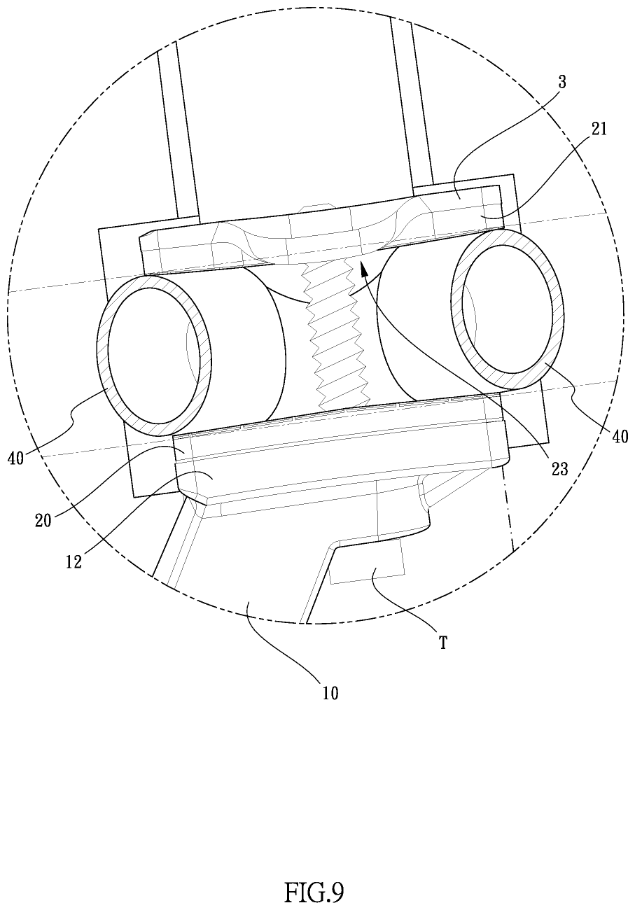

It is noteworthy that advantageous, essential technical features of the disclosure are further described below. The coupling portion 12 of the stand 1 is not in direct contact with the two chainstay tubes 40 of the bicycle frame 4; instead, the coupling portion 12 of the stand 1 is coupled to the first packing block 20 and then abutted against (because of the first packing block 20) the lower sides of the two chainstay tubes 40. Likewise, the fitting component 3 is not in direct contact with the two chainstay tubes 40 of the bicycle frame 4; instead; the fitting component 3 is coupled to the second packing block 21 and then abutted against (because of the second packing block 21) the upper sides of the two chainstay tubes 40. With the first packing block 20 and the second packing block 21 being made of a resilient material, A depression structure 23 (shown in FIG. 8 and FIG. 9) is centrally formed on the second packing block 21 and face the two chainstay tubes 40 because the second packing block 21 is tightly fitted to the fixing component T penetratingly disposed at both the first packing block 20 and the second packing block 21. The depression structure 23 is conducive to the enhancement of the tightness of the contact between the first and second packing blocks 20, 21 and the chainstay tubes 40.

The lower side of the first packing block 20 is in frictional contact with the plurality of friction bumps 131 on the surface of the coupling portion 12. The plurality of first ribs 200 on the upper side of the first packing block 20 are in frictional contact with the lower sides of the two chainstay tubes 40. The plurality of second ribs 212 on the lower side of the second packing block 21 are in frictional contact with the upper side of the two chainstay tubes 40. The plurality of embedding posts 211 on the upper side of the second packing block 21 are embeddedly disposed at the plurality of embedding holes 31 of the fitting component 3. Thus, the disclosure is conducive to increasing the friction between the first packing block 20, the second packing block 21 and the two chainstay tubes 40 when the first packing block 20 and the second packing block 21 are fitted to the upper and lower sides of the two chainstay tubes 40, respectively, so as to enhance the stability of the assembly of the stand 1 and the two chainstay tubes 40.

Therefore, the bicycle kickstand of the disclosure is advantageous in that the packing component 2 made of a resilient material functions as a medium of contact between the kickstand and the two chainstay tubes 40 to prevent the formation of any gaps between the coupling portion 12, the fitting component 3 and the two chainstay tubes 40 otherwise arising from the direct friction therebetween. The formation of such gaps is detriment to the two chainstay tubes 40. Furthermore, the packing component 2 is conducive to further increasing the friction between the coupling portion 12, the fitting component 3 and the two chainstay tubes 40 and enhancing assembly stability, allowing the stand 1 to support the bicycle steadily in both the supporting state and the folded state.

The position-limiting portions 30 of the fitting component 3 abut against the position-limiting trenches 210 of the second packing block 21 and vice versa to allow the two opposing sides of the fitting component 3 to be tightly fitted to the second packing block 21, precluding the noise and vibration which might otherwise be generated by the fitting component 3 to the detriment of the bicycle frame 4 while the user is riding the bicycle.

The first packing block 20 and the coupling portion 12 are coupled together through the coupling blocks 201 and the coupling dents 130, respectively. The second packing block 21 and the fitting component 3 are embeddedly fitted together through the embedding posts 211 and the embedding holes 31, respectively. Thus, the disclosure is conducive to the enhancement of the tightness of coupling the first packing block 20. the second packing block 21. the coupling portion 12 and the fitting component 3 together.

What is claimed is:

1. A bicycle kickstand, mounted on two chainstay tubes of a bicycle frame, comprising:
a stand having a coupling portion;
a fitting component;
a packing component made of a resilient material and having a first packing block and a second packing block, the first packing block having a surface coupled to the coupling portion of the stand, and the second packing block having a surface coupled to the fitting component.

2. The bicycle kickstand of claim 1, wherein the coupling portion, the first packing block, the second packing block and the fitting component each have a fixing hole, the fixing holes corresponding in position to each other and being penetrated by a fixing component, allowing the coupling portion to be coupled to the first packing block, then allowing the first packing block to abut against lower sides of the two chainstay tubes, next allowing the fitting component to be coupled to the second packing block, and finally allowing the second packing block to abut against upper sides of the two chainstay tubes.

3. The bicycle kickstand of claim 2, wherein a plurality of first ribs are disposed on an upper surface of the first packing block and are in contact with the lower sides of the two chainstay tubes, and a plurality of second ribs are disposed on a lower surface of the second packing block and are in contact with the upper sides of the two chainstay tubes.

4. The bicycle kickstand of claim 3, wherein the first ribs of the first packing block and the second ribs of the second packing block are arranged in a grid pattern.

5. The bicycle kickstand of claim 2, wherein a depression structure is centrally formed on the second packing block and face the two chainstay tubes because the second packing block is tightly fitted to the fixing component when the first packing block and the second packing block abut against the two chainstay tubes, and the depression structure is conducive to enhancement of tightness between the first packing block, the second packing block and the two chainstay tubes.

6. The bicycle kickstand of claim 1, wherein a short side of the coupling portion has an oblique surface with a gradually decreasing thickness, and the oblique surface is conducive to increasing an angle by which the stand pivotally swings.

7. The bicycle kickstand of claim 1, wherein a plurality of friction bumps are disposed on a top surface of the coupling portion and are in contact with a bottom of the first packing block.

8. The bicycle kickstand of claim 7, wherein the friction bumps are round, conical or cubic in shape.

9. The bicycle kickstand of claim 1, wherein the first packing block and the second packing block of the packing component are made of a resilient, composite material comprising rubbers bonded to fibers.

10. The bicycle kickstand of claim 1, wherein a plurality of coupling dents are disposed on a top surface of the coupling portion, and a plurality of coupling blocks corresponding in position to the coupling dents on the coupling portion are disposed at a bottom of the first packing block.

11. The bicycle kickstand of claim 1, wherein two position-limiting trenches are concavely disposed on two long sides of the second packing block, respectively, and two position-limiting portions are convexly disposed on two long sides of the fitting component and correspond in position to the position-limiting trenches of the second packing block, respectively.

12. The bicycle kickstand of claim 11, wherein an upper surface of the fitting component curves inward and concavely and extends downward to form the position-limiting portions which are plate-shaped.

13. The bicycle kickstand of claim 1, wherein a plurality of embedding posts are disposed on an upper surface of the second packing block, and a plurality of embedding holes are disposed on a lower surface of the fitting component and correspond in position to the embedding posts of the second packing block, respectively.

14. The bicycle kickstand of claim 1, wherein the stand has two ends at which a pivotal connection portion and a hooflike portion are disposed, respectively, and the pivotal connection portion is connected to the coupling portion.
